(19) United States
(12) Patent Application Publication
(10) Pub. No.: US 2006/0001512 A1
(43) Pub. Date: Jan. 5, 2006

(54) Rotary control for a communication device

(76) Inventors: Jorge L. Garcia, Plantation, FL (US); Charles B. Swope, Coral Springs, FL (US); Daniel A. Tealdi, Hialeah, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/883,133

(22) Filed: Jul. 1, 2004

(51) Int. Cl. H01H 9/00

(52) U.S. Cl. 335/205

(57) ABSTRACT

A rotary control assembly (400) for a communication device includes a magnetic sensor (410) integrated within a housing (406) and a magnet (404) integrally coupled to a rotary control (402) for controlling the magnetic sensor. User rotation of the rotary control (402) and integral magnet (404) controls resistance of the magnetic sensor (410). The variation in resistivity of the magnetic sensor (410) corresponds to selection options associated with the rotary control. The rotary control assembly (400) provides a self-sealed environment. Either continuous variable control or defined detent control can be incorporated into a communication device using assembly (400).

### FIELD OF THE INVENTION

This invention relates generally to rotary controls, and more particularly to sealed rotary controls for use on communication devices.

### BACKGROUND OF THE INVENTION

Sealed rotary controls are highly desirable in two-way radio and public safety phone applications. Rotary controls are often preferred over up-down toggle controls, because rotary controls tend to be easier to use. Rotary controls provide quick tactile and visual feedback of a current radio setting to a user. However, current rotary switch/pot technology tends to be more costly and difficult to implement than a simple dome rocker, particularly when a sealed assembly is needed.

Accordingly, there is a need for a rotary control for use on a communication device that eliminates the need for costly additional sealing features.

### BRIEF DESCRIPTION OF THE FIGURES

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a block diagram of a single-axis giant magnetoresistive sensor as known in the art;

FIG. 2 is a block diagram of a two-axis giant magnetoresistive sensor as known in the art;

FIG. 3 is a graph of angle of rotation versus relative signal response for a typical single-axis giant magnetoresistive sensor as known in the art;

FIG. 4 is a cross sectional view of a rotary control assembly in accordance with a low profile embodiment of the present invention;

FIG. 5 is an example of various communication devices incorporating the low profile rotary control embodiment of the invention;

FIG. 6 is an example of the rotary control assembly of the present invention incorporated into a high profile embodiment;

FIG. 7 is an example of a radio incorporating the high profile rotary control embodiment of the invention;

FIG. 8 is an example of a graph representing angle of rotation vs. relative signal level for an eight position switch utilizing the dual-axis sensor embodiment of the invention; and

FIG. 9 is an example of a graph representing angle of rotation vs. relative signal level for an eight position switch utilizing the single-axis sensor embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

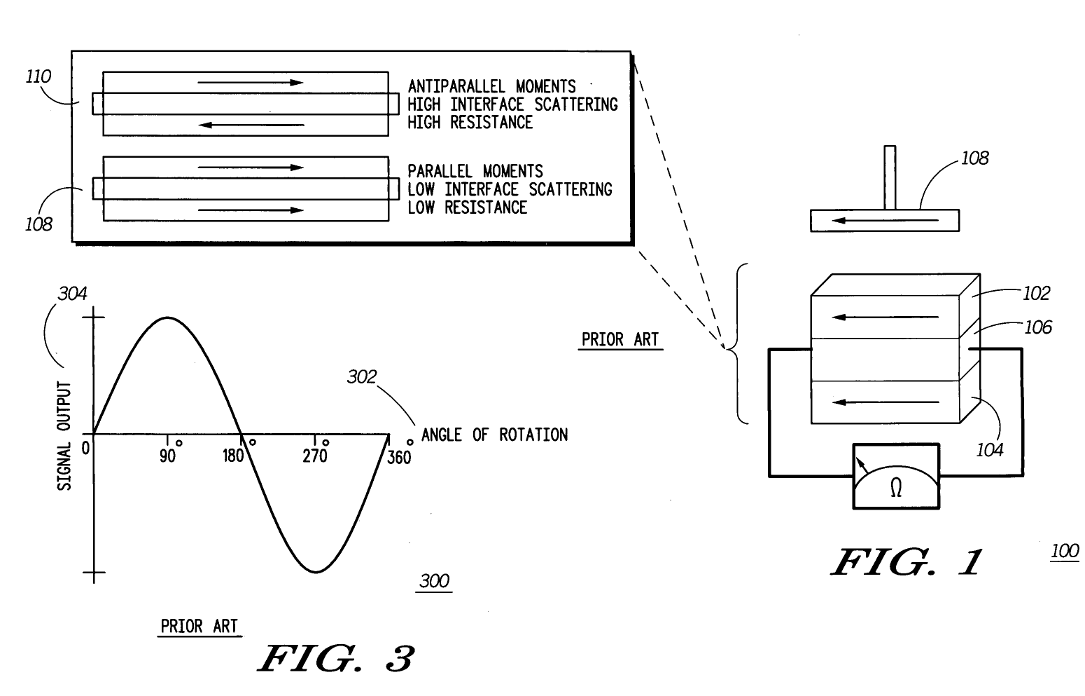

FIG. 1 is a block diagram of a single-axis giant magnetoresistive (GMR) sensor 100 as known in the art. The GMR sensor 100 includes two thin ferromagnetic layers 102, 104 separated by a thin nonmagnetic conductor layer 106. A magnetic field is provided by a magnet 108. The resistance of the nonmagnetic layer 106 can be altered by changing the moments of the ferromagnetic layers 104, 106 from parallel 110 to anti-parallel 112 using the magnet 108. Parallel moments 110 produce low interface scattering in the nonmagnetic conductor layer 106 thereby producing low resistance while anti-parallel moments 112 produce high interface scattering in conductor layer 106 thereby producing high resistance. Single axis GMRs are typically used for linear motion detection.

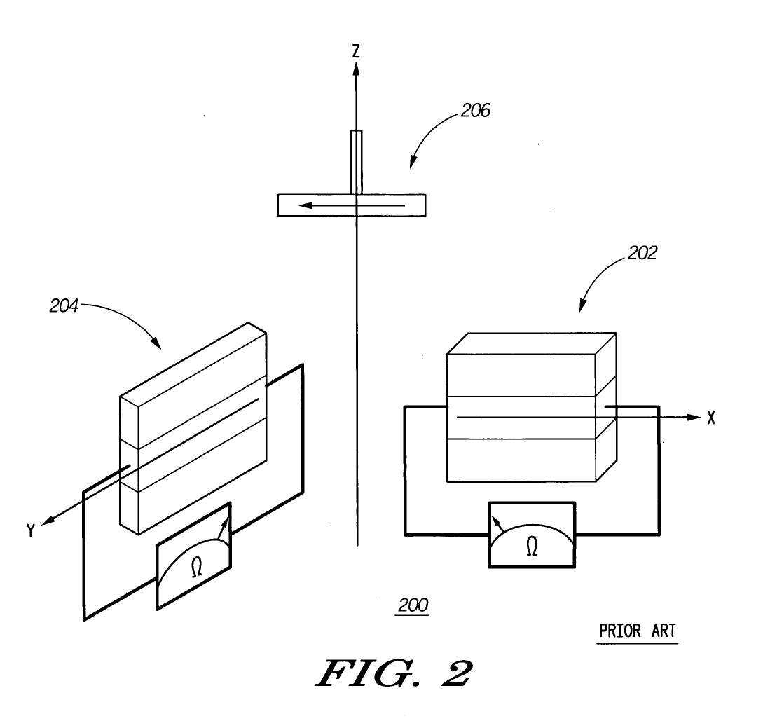

FIG. 2 is a block diagram of a two-axis giant magnetoresistive sensor 200 as known in the art. These devices can read the direction of the earth's magnetic field using two orthogonal magnetic sensors so that a processor can determine and display “north”. In configuration 200, two GMRs 202, 204 are placed orthogonal to each other (x-axis, y-axis) and the resistance is controlled by magnet 206 (z-axis). These sensors are supplied power and are periodically sampled with offset corrections, to compute heading or B-Field orientations. Two-axis magnetoresistive sensors have been used on portable radios to provide inexpensive integrated compass features. Both the single-axis and two-axis sensors are available in integrated circuit (IC) package form.

FIG. 3 is a graph 300 representing an example of angle of rotation 302 versus relative signal output 304 for a typical single-axis GMR sensor as known in the art. Signal output would typically be in units of mV/degree and is generated from the external B-Field alignment with magnetoresistive elements and measured by the sensor. As seen from graph 300, the response for a single-axis sensor resembles an ideal sine wave. For the two-axis magnetic sensors, the sensors provide x-axis and y-axis magnetic sensing of the magnetic fields (e.g. the earth's) field. Although not shown, a dual sine wave, 90 degrees out of phase, (i.e. a sine and cosine wave) would be representative of the orthogonally mounted two-axis sensor.

In accordance with the present invention, there is disclosed herein a cost effective rotary control solution that utilizes a magnetic sensor, preferably a giant magnetoresistive sensor, in a rotary control application for a communication device. In accordance with the present invention, a magnet is integrally formed as part of the rotary control to control the magnetic sensor and provide an inexpensive self-sealing rotary control assembly.

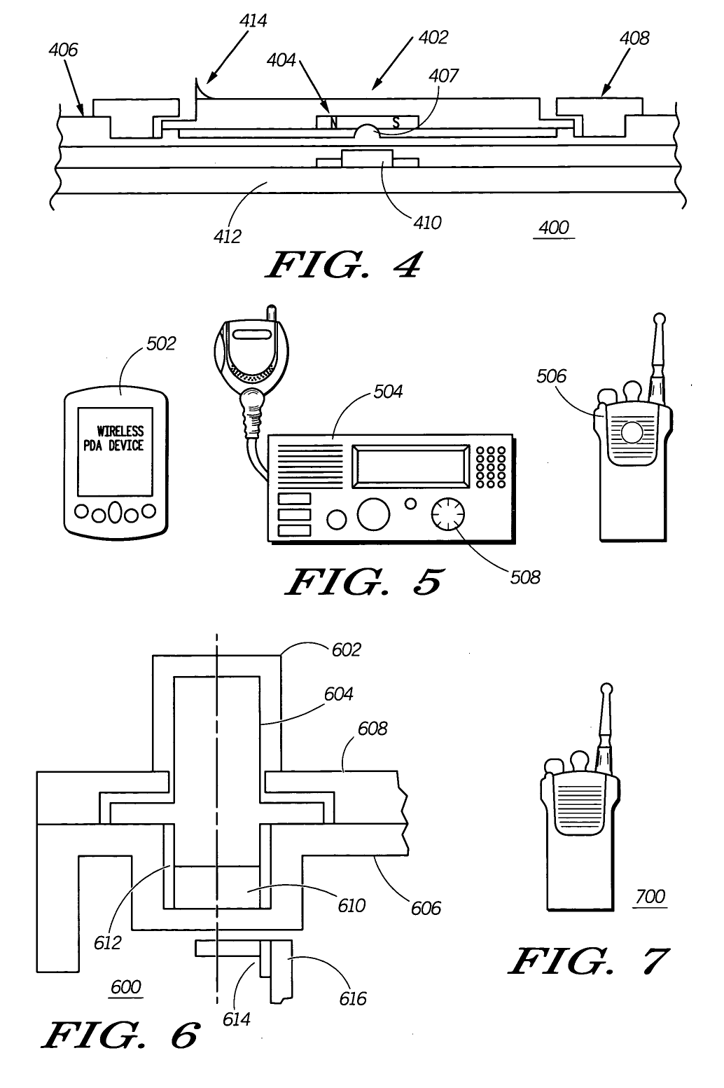

FIG. 4 is a cross sectional view of a rotary control assembly 400 in accordance with a low profile embodiment of the invention. Assembly 400 comprises a rotary control 402 having a magnet 404 integrated thereon, either by attachment, molding or other suitable means. The rotary control 402 is preferably formed with a low friction surface to prevent binding during rotation. The rotary control 402 with integrated magnet 404 sits upon a housing 406 of a communication device. Housing 406 includes a pivot point 407 formed thereon and upon which the magnet 404 is seated. A cover 408 is positioned to retain the rotary control 402 to the housing 406 while allowing the rotary control to rotate. A magnetic sensor 410, shown in integrated chip (IC) form, is coupled to a circuit board 412 and seated beneath the magnet 404. Magnetic sensor 410 is coupled to electronic circuitry (not shown), such as a microprocessor.

In accordance with the present invention, as a user rotates the rotary control 402, the integral magnet 404 rotates and controls the resistivity of the magnetic sensor 410. The variation in resistivity levels correspond to selection options associated with the rotary control. Assembly 400 provides the advantage of being self-sealing because there is no opening between the housing 406 and the magnetic sensor 410.

Magnet 404 should be selected to be strong enough to overpower external magnetic fields but not oversaturate the sensor. An example of a suitable magnetic sensor is a single-axis or two-axis magnetic resistive sensor, such as the GMRs described above. The resistance of each axis of sensitivity of the sensor 410 changes as the magnet 404 above is rotated. For the two-axis approach, the two-axis magnetic sensors providing x-axis and y-axis magnetic sensing of the earth's field are supplied power and generate output voltages that are processed into a computed heading or B-Field orientation. The output of the sensors can be analog or digital depending on the device. The microcontroller or microprocessor takes in the heading in either format relative to a predetermined zero angle as measured from a frame of reference (e.g. a zero position may point in the same direction as a radio speaker or display).

Assembly 400 can be implemented using a single-axis or two-axis sensor depending on the application. A single-axis sensor can be utilized in discrete position applications, such as channel change or zone change on a communication device. A two-axis sensor can be utilized for either discrete (e.g. channel/zone change) or continuous rotary applications (e.g. volume). Detents 414 or a bearing system can be added to assembly 400 to provide discrete positions for a single-axis or two-axis magnetic sensor.

The directionality of the B-field generated by the magnet 404 can be further enhanced by introducing B-field conducting material in the magnetic sensor area. The higher concentration of B-field lines yields higher directionality and increased resolution that provide smoother transitions or increased positions in a position switch if desired. Additional magnets can be used to provide additional control of the B-Fields as well.

FIG. 5 is a sample of communication devices incorporating a rotary control assembly formed in accordance with the present invention. Each rotary control comprises at least one magnetic sensor integrated within a variety of communication devices such as a personal organizer 502, mobile radio control head 504 and portable radio 506. Detents 508 are shown on mobile radio 504 to indicate an example of discrete positions for a single-axis or two-axis magnetic resistive sensor. The benefit to each of these communication devices is that external seals are no longer needed since the magnetic sensor is incorporated within the communication device housing and the magnet is integrated as part of the rotary control.

FIG. 6 is cross sectional view of a rotary control assembly 600 formed in accordance a high profile embodiment of the invention, such as for a channel control or volume pot of a communication device. Assembly 600 includes a knob 602 having an internal shaft 604 coupled between a radio housing 606 and housing cover 608. The shaft 604 provides the rotary control for this embodiment. In accordance with the present invention, a magnet 610 is integrally coupled to the shaft 604. The housing 606 includes a recess 612 formed therein and within which the magnet 610 is enclosed. A magnetic sensor 614 is shown in IC package form mounted to printed circuit board (pcb) 616 and aligned within the housing 606 under the magnet 610. The pcb 616 is vertically oriented in this view but the overall alignment of sensor 614 to magnet 610 is similar to that of FIG. 4.

As a user turns knob 602, the corresponding rotation of the shaft 604 and integral magnet 610 is sensed by magnetic sensor 614. Thus, the magnetic sensor 614 varies resistivity in response to user input (rotation). The variation in resistivity corresponds to selection options associated with the rotary control as described in FIG. 4. Here again the assembly configuration of the high profile embodiment provides self-sealing because there is no opening between the housing 606 and the magnetic sensor 614.

FIG. 7 is an example of a portable radio 700 incorporating the high profile embodiment of the rotary control assembly of the invention. An example of the high profile embodiment includes but is not limited to channel control and volume control for a two-way radio, cell phone or other communication device.

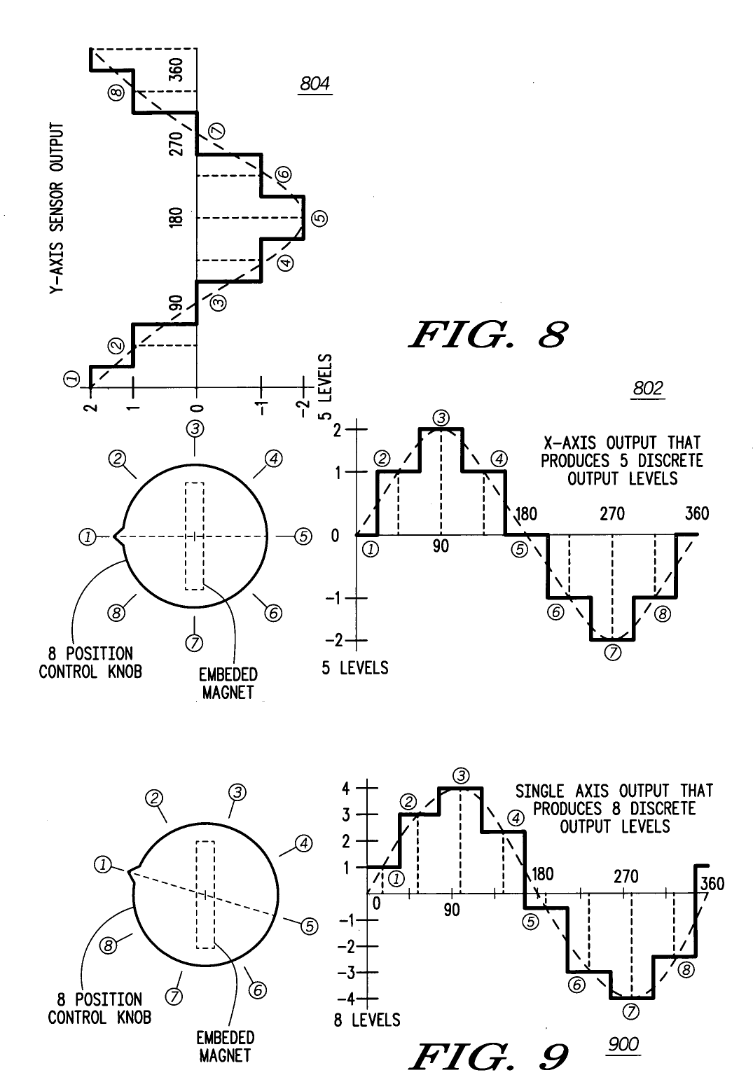

As mentioned previously, magnetic sensor 410 or 614 can be either two-axis or single-axis sensors. For the two-axis sensor, continuous variable resistance is provided as the rotary control with integrated magnet 404 is rotated by the user. The two-axis approach is highly desirable for applications such as volume adjustment on a radio or other communication device. The two-axis approach can also be used in discrete position applications as will be described in conjunction with FIG. 8. Since a single-axis sensor can not distinguish the B-field direction when it is orthogonal to the direction of sensitivity, a discreet positional embodiment is used to avoid the points where the B-field is orthogonal to the sensor direction of sensitivity. Thus, for the single-axis sensor, detents or a bearing system are used to provide the discrete positions. The use of discrete positions allows, for example, a multi-position sensor to ignore the positions where the magnet's B-field is orthogonal to the sensor direction of sensitivity.

FIG. 8 is an example of a graph representing angle of rotation vs. relative signal level for an eight position switch utilizing the dual-axis sensor embodiment of the invention. The sensor output signals are shown split into two graphs, one graph 802 representing an x-axis sensor output and the other graph 804 representing a y-axis sensor output. Rotary control positions have been labeled 1-8 about an embedded magnet and corresponding switch positions have been identified on the graphs. A seen from graphs 802, 804 rotation through eight positions (45 degrees each) produces a symmetric response. The Table below lists each rotary control position and corresponding relative level.

| Rotary control | x-axis | y-axis |
|---|---|---|
| position | level | level |
| 1 (0°) | 0 | 2 |
| 2 (45°) | 1 | 1 |
| 3 (90°) | 2 | 0 |
| 4 (135°) | 1 | −1 |
| 5 (180°) | 0 | −2 |
| 6 (225°) | −1 | −1 |
| 7 (270°) | −2 | 0 |
| 8 (315°) | −1 | 1 |

As seen from the Table and graphs 802, 802, each axis resolves to five relative discrete output levels (−2, −1, 0, 1, 2). Eight discrete output combinations (0, 2), (1, 1), (2, 0), (1, −1), (0, −2), (−1, −1), (−2, 0) and (−1, 1) are generated by using the two-axis approach thereby providing eight discrete positions. The discrete dual-axis implementation can be used for say a channel control or zone control on a radio or other communication device.

FIG. 9 is an example of a graph representing angle of rotation vs. relative signal level for an eight position switch utilizing the single-axis sensor embodiment of the invention. Here, the response of the sensor to the magnet is configured to produce an asymmetrical response so that each of the eight switch positions corresponds to a different relative signal level. By skewing each detent position relative to the magnet (or skewing the magnet relative to the detents) the non-symmetrical response is achieved. As seen from graph 900, the single-axis sensor output produces eight discrete levels. Again, this embodiment can be used for a channel change control, zone control or other feature on a two-way radio or other communication device in which discrete positions are desirable. The single-axis embodiment provides a significant cost advantage when discrete positions are desired since only one sensor is used.

Accordingly, there has been provided a rotary control assembly implemented with a magnetic sensor and magnet that avoids the use of external seals (i.e. self-sealing). As discussed above, the magnetic sensor may comprise one or more magnetic sensors depending on the application desired. At least one magnet is used to control the one or more sensors. The benefits of incorporating a magnet and magnetic sensor into a rotary control assembly include the elimination of additional environmental seals and reduced cost.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. A rotary control assembly for a communication device, comprising:
a magnetic sensor integrated within the communication device;
a rotary control coupled to the communication device; and
a magnet integrally coupled to the rotary control for controlling the magnetic sensor.

2. The rotary control assembly of claim 1, wherein user rotation of the rotary control and integral magnet controls resistance of the magnetic sensor.

3. The rotary control assembly of claim 1, wherein the magnetic sensor comprises a two-axis magnetic sensor.

4. The rotary control assembly of claim 1, wherein the magnetic sensor comprises a single-axis magnetic sensor.

5. The rotary control assembly of claim 1, wherein the rotary control assembly is self-sealing.

6. A rotary control assembly for a communication device, comprising:
a rotary control having an integrated magnet;
a housing, the rotary control having the integrated magnet seated upon the housing;
a cover positioned to retain and allow rotation of the rotary control on the housing; and
a magnetic sensor coupled to a circuit board, the magnetic sensor seated beneath the magnet within the housing.

7. The rotary control assembly of claim 6, wherein the magnetic sensor responds to user input via rotation of the rotary control.

8. The rotary control assembly of claim 6, wherein the rotary control comprise a low profile rotary control.

9. The rotary control assembly of claim 6, wherein the rotary control comprises a high profile rotary control.

10. The rotary control assembly of claim 9, wherein the high profile rotary control comprises a shaft having the integrated magnet coupled thereto.

11. The rotary control assembly of claim 6, wherein the housing includes a pivot point formed thereon and upon which the magnet is seated.

12. The rotary control assembly of claim 6, wherein the housing includes a recess formed therein and within which the integrated magnet is enclosed.

13. The rotary control assembly of claim 6, wherein the magnetic sensor comprises a two-axis magnetic sensor.

14. The rotary control assembly of claim 6, wherein the magnetic sensor comprises a single-axis magnetic sensor.

15. The rotary control assembly of claim 6, wherein the magnetic sensor is calibrated to the magnet's strength.

16. The rotary control assembly of claim 6, wherein the magnetic sensor is characterized by an axis of sensitivity having a resistivity that changes as the magnet is rotated.

17. The rotary control assembly of claim 6, further comprising B-field conducting material in proximity with the magnetic sensor that enhances directionality B-fields generated by the magnet.

18. The rotary control assembly of claim 6, wherein the rotary control provides either a volume control, channel change control or zone control of the communication device.

19. A rotary switch, comprising:
a rotary control;
a magnet integrated with the rotary control; and
a magnetic sensor responsive to the magnet within the rotary control.

20. The rotary switch of claim 19, wherein the rotary switch is incorporated in a radio.

21. The rotary switch of claim 19, wherein the magnetic sensor is a single-axis sensor.

22. The rotary switch of claim 19, wherein the magnetic sensor is a single-axis giant magnetoresistive sensor.

23. The rotary switch of claim 19, wherein the magnetic sensor is a two-axis sensor.

24. The rotary switch of claim 19, wherein the magnetic sensor is a two-axis giant magnetoresistive sensor.

25. The rotary switch of claim 19, wherein the magnet and the magnetic sensor are configured to provide a symmetric response throughout rotation of switch positions of the rotary switch.

26. The rotary switch of claim 25, further comprising detents aligned with each switch position of the rotary switch.

27. The rotary switch of claim 19, wherein the magnet and the magnetic sensor are configured to generate an asymmetric response throughout rotation of switch positions of the rotary switch.

28. The rotary switch of claim 27, further comprising detents aligned with each switch position of the rotary switch.

29. The rotary switch of claim 23, wherein the two-axis magnetic sensor and magnet provide continuous variable control.

30. The rotary switch of claim 24, wherein the two-axis giant magnetoresistive sensor and magnet provide continuous variable control.
